(19) United States
(12) Patent Application Publication
(10) Pub. No.: US 2012/0062487 A1
(43) Pub. Date: Mar. 15, 2012

(54) Touch Screen Panel and Display Device Having the Same

(75) Inventors: Keun-Soo Lee, Yongin-City (KR); Seung-Yeon Cho, Yongin-City (KR)

(73) Assignee: SAMSUNG MOBILE DISPLAY CO., LTD., Yongin-City (KR)

(21) Appl. No.: 13/217,582

(22) Filed: Aug. 25, 2011

(30) Foreign Application Priority Data
Sep. 14, 2010 (KR) 10-2010-0090062

(51) Int. Cl. G06F 3/041

(52) U.S. Cl. 345/173

(57) ABSTRACT

A touch screen panel and a display device having the same are capable of improving visibility and suppressing the occurrence of a failure caused by static electricity. In one embodiment, the touch screen panel includes a plurality of first sensing cells arranged along a first direction for each column on a transparent substrate. A first connection pattern electrically connects adjacent first sensing cells to each other. A plurality of second sensing cells are arranged along a second direction for each row while being spaced apart from the first sensing cells. A second connection pattern electrically connects adjacent second sensing cells to each other. In the touch screen panel, the first connection pattern comprises a pair of metal patterns and two pairs of dummy transparent patterns.

### CLAIM OF PRIORITY

This application makes reference to, incorporates the same herein, and claims all benefits accruing under 35 U.S.C. §119 from an application earlier filed in the Korean Intellectual Property Office on the 14 of Sep. 2010 and there duly assigned Ser. No. 10-2010-0090062.

### BACKGROUND OF THE INVENTION

1. Field of the Invention

The present invention relates to a touch screen panel and a display device having the same and, more particularly, to a touch screen panel and a display device having the same which are capable of improving visibility and suppressing the occurrence of a failure caused by static electricity.

2. Description of the Related Art

As the demand for various types of display devices has recently increased with the development of an information society, studies on display devices such as a liquid crystal display device (LCD), a plasma display panel (PDP), a field emission display device (FED), an electrophoretic display device (EPD) and an organic light emitting display device (OLED) have been actively conducted.

Recently, studies have been conducted to apply a touch screen panel function to such a display device. A touch screen panel is an input device which allows an instruction to be inputted by touching a screen of a display using an object, such as a finger or a pen. Since such a touch screen panel can be substituted for a separate input device built into and operated in a display device, such as a keyboard or mouse, its application fields have been gradually extended.

Touch screen panels are divided into a resistive overlay touch screen panel, a photosensitive touch screen panel, a capacitive touch screen panel, and the like. Among these touch screen panels, the capacitive touch screen panel converts a contact position into an electrical signal by sensing a change in capacitance formed between a conductive sensing pattern and an adjacent sensing pattern, ground electrode or the like when a user's hand or object is placed in contact with the touch screen panel.

The sensing patterns include first sensing patterns formed so as to be connected along a first direction and second sensing patterns formed so as to be connected along a second direction. The first and second sensing patterns are respectively disposed in different layers with an insulating layer interposed therebetween.

When sensing patterns are respectively formed in different layers as described above, the surface resistance of a transparent conductive material used to form the sensing patterns is large. Therefore, in order to decrease the surface resistance, there has been proposed a method in which the width of a connection portion for connecting the sensing patterns positioned in the same layer is implemented so as to be wide. However, the overlapping area of the connection portions respectively positioned in the upper and lower layers is increased, and the capacitance for the overlapping area is also increased. Therefore, the sensitivity of each of the sensing patterns is lowered.

Recently, in order to solve such a problem, there has been proposed a method in which the first and second layers are formed in the same layer, and a connection pattern is made of a metallic material having a low resistance through a contact hole formed in the insulating layer positioned on the first or second sensing patterns so that the first or second sensing patterns are connected therethrough.

However, the connection pattern is weak with respect to static electricity at a portion at which it overlaps with the transparent conductive material positioned on the insulating layer, and hence a failure such as a short circuit is caused. In the case where a plurality of connection patterns are used to prevent the failure caused by static electricity, the reflection of light is increased and the light emitting area below the connection patterns is decreased as the connection patterns made of a metallic material are increased, thereby resulting in the degradation of visibility.

### SUMMARY OF THE INVENTION

In one embodiment of the invention, there is provided a touch screen panel and a display device which are capable of improving visibility and suppressing the occurrence of a failure caused by static electricity.

According to an aspect of the present invention, there is provided a touch screen panel comprising: a plurality of first sensing cells arranged along a first direction for each column on a transparent substrate; a first connection pattern which electrically connects adjacent first sensing cells to each other; a plurality of second sensing cells arranged along a second direction for each row while being spaced apart from the first sensing cells; and a second connection pattern which electrically connects adjacent second sensing cells to each other; wherein the first connection pattern comprises a pair of metal patterns and two pairs of dummy transparent patterns.

According to an aspect of the present invention, there is provided a display device having a touch screen panel, the display device comprising: a display panel which displays images; a plurality of first sensing cells arranged along a first direction for each column on the display panel; a first connection pattern which electrically connects adjacent first sensing cells to each other; a plurality of second sensing cells arranged along a second direction for each row while being spaced apart from the first sensing cells; and a second connection pattern which electrically connects adjacent second sensing cells to each other; wherein the first connection pattern comprises a pair of metal patterns and two pairs of dummy transparent patterns.

The pair of metal patterns may be formed of a low-resistance metallic material such as molybdenum (Mo), silver (Ag), titanium (Ti), copper (Cu), aluminum (Al) or molybdenum/aluminum/molybdenum (Mo/Al/Mo).

The pair of metal patterns may be disposed in an area interposed with the second connection pattern, with an insulating layer interposed therebetween. The pair of metal patterns may be arranged in parallel so as to be spaced apart from each other. The pair of metal patterns may be electrically connected to the first sensing cells through the two pairs of dummy transparent patterns.

The two pairs of dummy transparent patterns may be arranged so as to be spaced apart from each other with the second connection pattern interposed therebetween, and 1 1 electrically connected to both edge portions of the pair of metal patterns, respectively. The two pairs of dummy transparent patterns may be formed of indium tin oxide (ITO) or indium zinc oxide (IZO). The two pairs of dummy transparent patterns may be integrally formed with the first sensing cells.

The first and second sensing cells may be formed of ITO or IZO, and are arranged with the pair of metal patterns and the insulating layer interposed therebetween. The first sensing cell, the second sensing cell and the two pairs of dummy transparent patterns may be formed in the same layer.

As described above, according to embodiments of the present invention, a connection pattern which connects adjacent first sensing cells to each other is implemented as a pair of metal patterns and two pairs of dummy transparent patterns, and the pair of metal patterns are disposed so as to be spaced apart from each other, so that it is possible to improve the weakness relative to static electricity in the connection pattern, thereby preventing a failure.

Also, the adjacent first sensing cells and the pair of metal patterns are connected by the two pairs of dummy transparent patterns so that it is possible to minimize the use of the metal pattern, thereby enhancing visibility.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a sectional view of a display device having a touch screen panel according to an embodiment of the present invention.

FIG. 2 is a plan view of the touch screen panel shown in FIG. 1.

FIG. 3 is a main part enlarged view showing an embodiment of sensing cells and connection patterns in portion E shown in FIG. 2.

FIG. 4A is a main part sectional view of the touch screen panel taken along line A-A′ of FIG. 3.

FIG. 4B is a main part sectional view of the touch screen panel taken along line B-B′ of FIG. 3.

FIG. 4C is a main part sectional view of the touch screen panel taken along line C-C′ of FIG. 3.

### DETAILED DESCRIPTION OF THE INVENTION

In the following detailed description, only certain exemplary embodiments of the present invention have been shown and described, simply by way of illustration. As those skilled in the art will realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Furthermore, like reference numerals refer to like elements.

Hereinafter, a touch screen panel and a display device having the same according to an embodiment of the invention will be described in detail with reference to the accompanying drawings: I) shapes, sizes, rates, angles, numbers and the like, shown in the accompanying drawings are provided only for illustrative purposes, and may be modified to some extent; ii) since the drawings are viewed with an observer's eyes, directions or positions described in the drawings may be variously modified depending on the observer's positions; iii) like reference numerals may be used to indicate like parts throughout the drawings; iv) when the terms “comprise”, “have”, “include” and the like are used, other parts may be added as long as the term “only” is not used; v) the singular forms maybe interpreted as plural forms; vi) although the terms “about”, “substantially” and the like are not used, shapes, comparisons between sizes, relations between positions, and the like are interpreted to include an ordinary error range; vii) although the terms “after”, “before”, “subsequently”, “also”, “here”, “at this time” and the like are used, they are not used to limit temporal positions; viii) the terms “first”, “second”, “third” and the like are selectively, mutually or repeatedly used to distinguish between similar elements and are not used with confined meanings; ix) when the positional relationship between two parts is described using the terms “on”, “above”, “below”, “next” and the like, one or more parts may be positioned between the two parts as long as the term “immediately” is not used; and x) when parts are linked by the term “or”, they are interpreted individually or in combination, but when they are linked by the term “or one of” they are only interpreted individually.

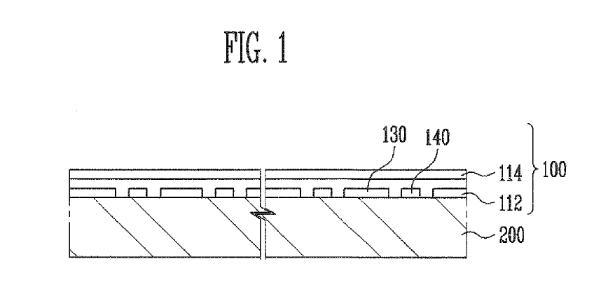

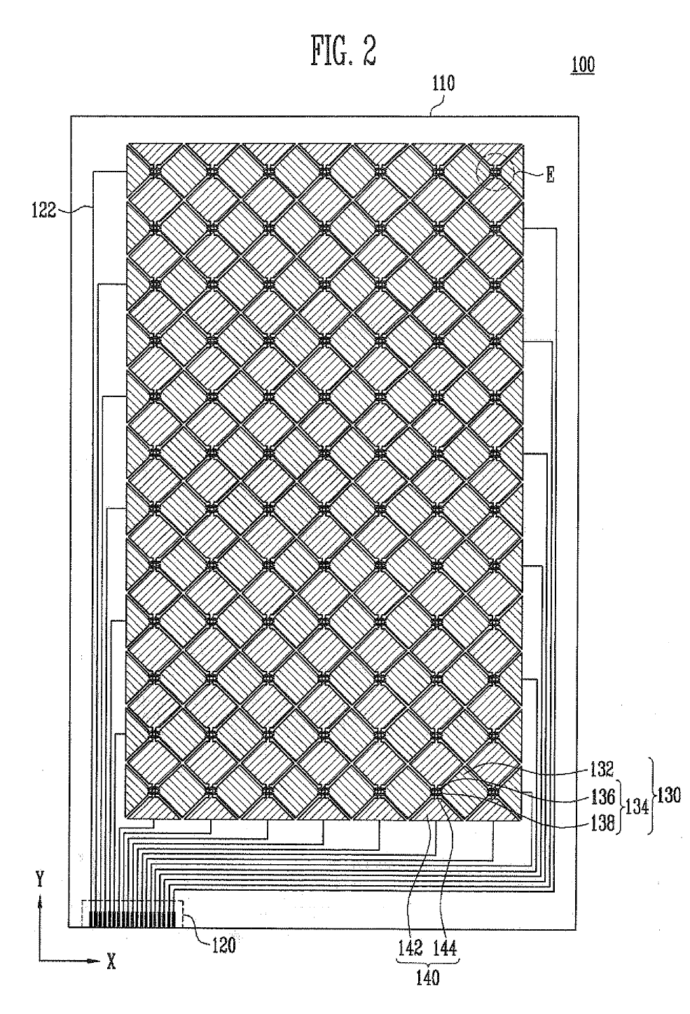

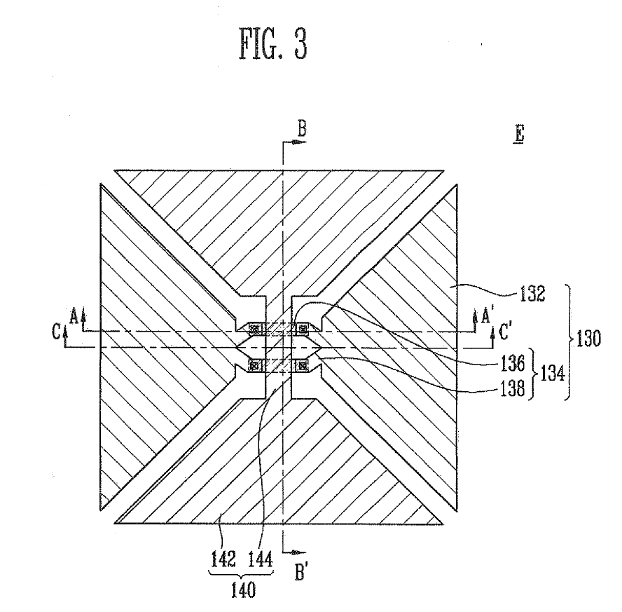

FIG. 1 is a sectional view of a display device having a touch screen panel according to an embodiment of the present invention, FIG. 2 is a plan view of the touch screen panel shown in FIG. 1, and FIG. 3 is a main part enlarged view showing an embodiment of sensing cells and connection patterns in portion E shown in FIG. 2.

Referring to FIG. 1, a display device having a touch screen panel includes a touch screen panel 100 to which an instruction is inputted at a contact position, and a display panel which displays an image based on the inputted instruction.

Referring to FIGS. 1 thru 3, the touch screen panel 100 includes a transparent substrate 110, sensing patterns 130 and 140 formed in an active area on the transparent substrate 110, and position detecting lines 122 formed in a non-active area at the outside of the active area.

The transparent substrate 110 may be an upper substrate which constitutes the display panel 200 in the display device. Alternatively, the transparent substrate 110 may be a separate substrate attached to the display panel 200.

The sensing patterns 130 and 140 are alternately arranged, and include first sensing patterns 130 formed so as to be connected to one another for each row having the same X coordinate and second sensing patterns 140 formed so as to be connected to one another for each column having the same Y coordinate. In this instance, the touch screen panel 100 is implemented as a capacitive touch screen panel in which the first sensing patterns 130 and the second sensing patterns 140 are alternately distributed and arranged in the active area.

The first sensing patterns 130 include first sensing cells 132 arranged along a first direction (column direction) for each column having the same X coordinate in the active area, and a first connection pattern 134 which connects the first sensing cells 132 to each other.

The first sensing cells 132 are made of a transparent conductive material having a predetermined transmittance or higher so that light from the display panel 200 disposed beneath the touch screen panel 100 can be transmitted for the purpose of implementing the operation of the touch screen panel 100. Indium tin oxide (ITO) or indium zinc oxide (IZO) may be used as the transparent conductive material.

In order to serve as sensing electrodes of the touch screen panel 100, the first sensing cells 132 arranged along the first direction are necessarily electrically connected to each other. Accordingly, the first sensing cells 132 are electrically connected to each other by the first connection pattern 134.

The first connection pattern 13 electrically connects the first sensing cells 132 along the first direction. To this end, the first connection pattern 134 includes a pair of metal patterns 136 formed along the first direction and two pairs of dummy transparent patterns 138.

The pair of metal patterns 136 has two metal patterns 136 arranged in parallel while being spaced apart from each other, and are arranged in an area overlapped with a second connection pattern 144 of the second sensing pattern 140. The pair of metal patterns 136 is formed in only the area overlapped with the second connection pattern, thereby enhancing visibility.

The pair of metal patterns 136 is formed of a low-resistance metallic material. The metallic material used for the plurality of metal patterns 136 may include a low-resistance metallic material such as molybdenum (Mo), silver (Ag), titanium (Ti), copper (Cu), aluminum (Al) or molybdenum/aluminum/molybdenum (Mo/Al/Mo).

The pair of metal patterns 136 may be formed of the same material as a metallic material used for the position detecting lines 122 formed in the non-active area of the touch screen panel 100. In this case, since the pair of metal patterns 136 is formed in the same layer through the same process as the position detecting lines 122, it is unnecessary to perform an additional mask process to form the pair of metal patterns 136, so that it is possible to reduce the number of processes and time.

The pair of metal patterns 136 made of a low-resistance metal is included in the first connection pattern 134 which connect the first sensing cells 132 to each other, so that the flow of charge can be activated at the connection portion between the first sensing cells 132, thereby increasing the sensitivity of the first sensing cells 132.

The two pairs of dummy transparent patterns 138 electrically connect the pair of metal patterns 136 to the first sensing cells 132. To this end, the two pairs of dummy transparent patterns 138 are arranged so as to be spaced apart from each other with the second connection pattern 144 interposed therebetween. Among the two pairs of dummy transparent patterns 138, one pair of dummy transparent patterns 138 are electrically connected to respective first ends of the pair of the metal patterns 136, respectively, and the other pair of dummy transparent patterns 138 are electrically connected to respective second ends of the pair of metal patterns 136.

That is, first ends of each of the two pairs of dummy transparent patterns 138, which include four dummy transparent patterns, are electrically connected to first ends of the pair of metal patterns 136, which include two metal patterns, respectively, and second ends of each of the two pairs of dummy transparent patterns 138 are electrically connected to the first sensing cell 132.

The two pairs of dummy transparent patterns 138 are made of a transparent conductive material having a predetermined transmittance or higher. ITO or IZO may be used as the transparent conductive material. The two pairs of dummy transparent patterns 138 may be made of the same material as the first sensing cell 132. The two pairs of dummy transparent patterns 138 may be integrally formed with the first sensing cell 132.

As shown in FIG. 3, the pair of metal patterns 136 and the two pairs of dummy transparent patterns 138 may be formed in the shape of a rectangular bar. However, this is provided only for illustrative purposes, and the patterns 136 and 138 are not necessarily limited to such a shape.

As described above, in this embodiment of the invention, the dummy transparent pattern 138 is provided as the first connection pattern 134 which connects the first sensing cells 132 to each other, in addition to the metal pattern, so that the area of the metal pattern can be minimized, thereby enhancing the visibility of the display device. Also, the metal pattern is formed with two metal patterns so that, although one metal pattern may be short circuited by static electricity, an electrical signal can be supplied through the other metal pattern. Thus, it is possible to improve the weakness relative to static electricity, thereby overcoming an electrostatic discharge (ESD) problem.

The second sensing patterns 140 include second sensing cells 142 arranged so as to be spaced apart from the first sensing cells 132 along a second direction (row direction) for each row having the same Y coordinate in the active area, and a second connection pattern 144 which connects the second sensing cells 142 to each other.

The second sensing cells 142 are made of a transparent conductive material having a predetermined transmittance or higher so that light from the display panel 200 disposed beneath the touch screen panel 100 can be transmitted for the purpose of implementing the operation of the touch screen panel 100. Indium tin oxide (ITO) or indium zinc oxide (IZO) may be used as the transparent conductive material. The second sensing cells 142 may be formed of the same material in the same layer as the first sensing cells 132.

In order to serve as sensing electrodes of the touch screen panel 100, the second sensing cells 142 arranged along the second direction are necessarily electrically connected to each other. Accordingly, the second sensing cells 142 are electrically connected to each other by the second connection pattern 144.

The second connection pattern 144 electrically connects the second sensing cells 142 to each other along the second direction. The second connection pattern 144 is made of a transparent conductive material so as to enhance the visibility of the touch screen panel 100. ITO or IZO may be used as the transparent conductive material. In this instance, the second connection pattern 144 may be integrally formed with the second sensing cell 142.

Since the first and second sensing cells 132 and 142, respectively, are formed in the same layer, the first and second connection patterns 134 and 144, respectively, at a portion at which they are overlapped with each other cannot be formed in the same layer so as to avoid a short circuit.

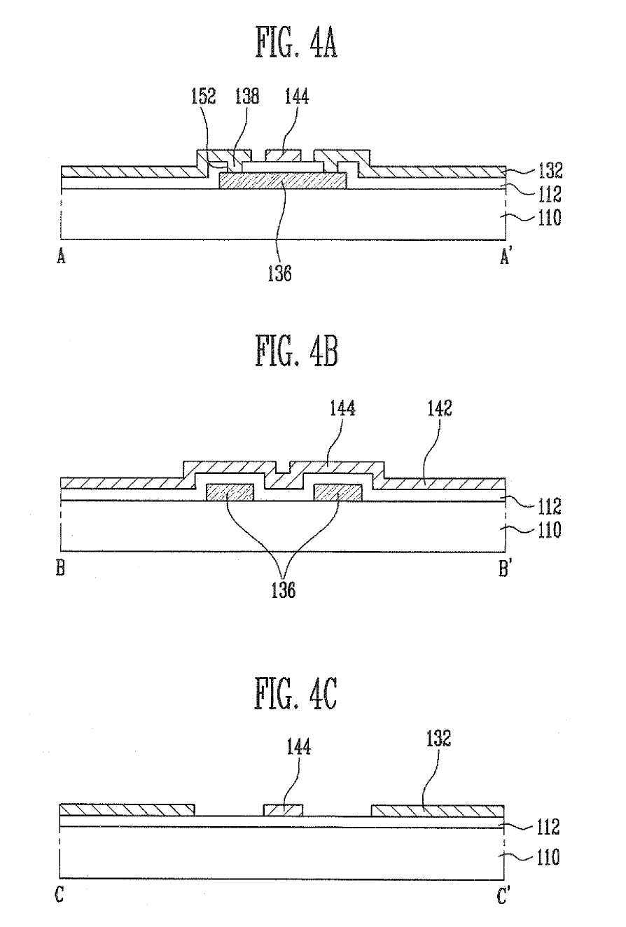

FIG. 4A is a main part sectional view of the touch screen panel taken along line A-A′ of FIG. 3, FIG. 4B is a main part sectional view of the touch screen panel taken along line B-B′ of FIG. 3, and FIG. 4C is a main part sectional view of the touch screen panel taken along line C-C′ of FIG. 3.

Referring to FIGS. 4A thru 4C, a pair of metal patterns 136 are formed on a transparent substrate 110, and an insulating layer 112 is formed on the transparent substrate 110 including the pair of metal patterns 136.

Portions of the insulating layer 112, respectively corresponding to both edge portions of the pair of metal patterns 136, are opened so that the pair of metal patterns 136 are exposed through contact holes 152 formed in the portions of the insulating layer 112, respectively. The pair of metal patterns 136 are electrically connected to first sensing cells 132 adjacent thereto by two pairs of dummy transparent patterns 138 formed so as to be buried in the contact holes 152, respectively. The two pairs of dummy transparent patterns 138 may be integrally formed with the first sensing cell 132.

The second connection pattern 144 is formed so as to be overlapped with the pair of metal patterns 136, so that it is electrically connected to the second sensing cells 142 adjacent thereto. The second connection pattern 144 may be integrally formed with the second sensing cell 142.

Since the first and second sensing cells 132 and 142, respectively, are formed in the same layer, they are formed so as to be spaced apart from each other at a predetermined interval so as to avoid a short circuit between the first and second sensing cells 132 and 142, respectively. Also, since the dummy transparent pattern 138 and the second connection pattern 144 are formed in the same layer, they are formed so as to be spaced apart from each other at a predetermined interval so as to avoid a short circuit between the dummy transparent pattern 138 and the second connection pattern 144.

Although it has been described in this embodiment that the pair of metal patterns 136 is formed in a lower layer of the first and second sensing cells 132 and 142, respectively, and the dummy transparent patterns 138, it is not necessarily limited thereto.

The pair of metal pattern 136 may be formed in an upper layer of the first and second sensing cells 132 and 142, respectively, and the dummy transparent patterns 138. In this case, the detailed configuration and effect of this embodiment are identical to those of the aforementioned embodiment, except for the positions of the lower and upper layers.

Referring back to FIG. 2, the position detecting lines 122 are arranged in the non-active area of the touch screen panel 100, which is formed at the outside of the active area for displaying an image, so as to supply a signal sensed by the sensing patterns 130 and 140 to an external driving circuit (not shown) through a pad portion 120.

In this instance, the first sensing patterns 130 connected to one another along the first direction for each column are electrically connected to the respective position detecting lines 122. The second sensing patterns 140 connected to one another along the second direction for each row are electrically connected to the respective position detecting lines 122.

The position detecting line 122 may be formed of a low-resistance metallic material or transparent electrode material, such as molybdenum (Mo), silver (Ag), titanium (Ti), copper (Cu), aluminum (Al) or molybdenum/aluminum/molybdenum (Mo/Al/Mo).

As described above, the touch screen panel 100 is a capacitive touch screen panel. If the touch screen panel 100 is contacted by a contact object, such as a user's finger or stylus pen, a change in capacitance, caused by a contact position, is provided to the external driving circuit (not shown) through the position detecting lines 122 and the pad portion 120 from the sensing patterns 130 and 140. Then the change in capacitance is converted into an electrical signal by an X and Y input processing circuit (not shown) or the like, so that the contact position is detected.

Meanwhile, in this embodiment of the invention the first and second sensing cells 132 and 134, respectively, are not necessarily positioned in the same layer. For example, the first and second sensing cells 132 and 134, respectively, may be alternately arranged in different layers. The undescribed protection layer 114 is formed on the sensing patterns 130 and 140 so as to protect the sensing patterns 130 and 140 formed at a lower portion thereof. The insulating layer 112 and the protection layer 114 may be formed of a transparent insulating material, such as silicon oxide (SiO2).

The touch screen panel 100 according to this embodiment of the invention may be formed on an independent substrate so as to be attached to a top surface of the touch screen panel 100, or may be integrally formed with the display panel 200. That is, the plurality of first and second sensing patterns 130 and 140, respectively, disposed on the display panel 200 to receive a touch input, are directly formed on an upper substrate of the display panel 200 so that the touch screen panel 100 and the display panel 200 can be integrated with each other.

Meanwhile, it will be apparent that the display panel 200 may be implemented as various kinds of display panels for displaying images, such as a liquid crystal display panel and an organic light emitting display panel.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A touch screen panel, comprising:
a plurality of first sensing cells arranged along a first direction for each column on a transparent substrate;
a first connection pattern which electrically connects adjacent first sensing cells to each other;
a plurality of second sensing cells arranged along a second direction for each row while being spaced apart from the first sensing cells; and
a second connection pattern which electrically connects adjacent second sensing cells to each other;
wherein the first connection pattern comprises a pair of metal patterns and two pairs of dummy transparent patterns.

2. The touch screen panel according to claim 1, wherein the pair of metal patterns are formed of a low-resistance metallic material, such as molybdenum (Mo), silver (Ag), titanium (Ti), copper (Cu), aluminum (Al) or molybdenum/aluminum/molybdenum (Mo/Al/Mo).

3. The touch screen panel according to claim 1, wherein the pair of metal patterns are disposed in an area interposed with the second connection pattern, with an insulating layer interposed therebetween.

4. The touch screen panel according to claim 1, wherein the pair of metal patterns are arranged in parallel and are spaced apart from each other.

5. The touch screen panel according to claim 1, wherein the pair of metal patterns are electrically connected to the first sensing cells through the two pairs of dummy transparent patterns.

6. The touch screen panel according to claim 1, wherein the two pairs of dummy transparent patterns are arranged so as to be spaced apart from each other with the second connection pattern interposed therebetween, and are electrically connected to both edge portions of the pair of metal patterns, respectively.

7. The touch screen panel according to claim 1, wherein the two pairs of dummy transparent patterns are formed of one of indium tin oxide (ITO) and indium zinc oxide (IZO).

8. The touch screen panel according to claim 1, wherein the two pairs of dummy transparent patterns are integrally formed with the first sensing cells.

9. The touch screen panel according to claim 1, wherein the first and second sensing cells are formed of one of ITO and IZO, and are arranged with the pair of metal patterns and the insulating layer interposed therebetween.

10. The touch screen panel according to claim 1, wherein the first sensing cells, the second sensing cells and the two pairs of dummy transparent patterns are formed in a same layer.

11. A display device having a touch screen panel, said display device comprising:
a display panel which displays images;
a plurality of first sensing cells arranged along a first direction for each column on the display panel;
a first connection pattern which electrically connects adjacent first sensing cells to each other;
a plurality of second sensing cells arranged along a second direction for each row while being spaced apart from the first sensing cells; and
a second connection pattern which electrically connects adjacent second sensing cells to each other;
wherein the first connection pattern comprises a pair of metal patterns and two pairs of dummy transparent patterns.

12. The display device according to claim 11, wherein the pair of metal patterns are formed of a low-resistance metallic material, such as molybdenum (Mo), silver (Ag), titanium (Ti), copper (Cu), aluminum (Al) or molybdenum/aluminum/molybdenum (Mo/Al/Mo).

13. The display device according to claim 11, wherein the pair of metal patterns are disposed in an area interposed with the second connection pattern, with an insulating layer interposed therebetween.

14. The display device according to claim 11, wherein the pair of metal patterns are arranged in parallel and are spaced apart from each other.

15. The display device according to claim 11, wherein the pair of metal patterns are electrically connected to the first sensing cells through the two pairs of dummy transparent patterns.

16. The display device according to claim 11, wherein the two pairs of dummy transparent patterns are arranged so as to be spaced apart from each other with the second connection pattern interposed therebetween, and are electrically connected to both edge portions of the pair of metal patterns, respectively.

17. The display device according to claim 11, wherein the two pairs of dummy transparent patterns are formed of one of ITO and IZO.

18. The display device according to claim 11, wherein the two pairs of dummy transparent patterns are integrally formed with the first sensing cells.

19. The display device according to claim 11, wherein the first and second sensing cells are formed of one of ITO and IZO, and are arranged with the pair of metal patterns and the insulating layer interposed therebetween.

20. The display device according to claim 11, wherein the first sensing cells, the second sensing cells and the two pairs of dummy transparent patterns are formed in a same layer.
